(19) United States
(12) Patent Application Publication
(10) Pub. No.: US 2018/0172256 A1
(43) Pub. Date: Jun. 21, 2018

(54) ADAPTOR FOR FLUORESCENT LUMINAIRE

(71) Applicant: Philips Lighting Holding B.V., Eindhoven (NL)

(72) Inventors: Robertus Johannes Maria Mathilde SNIJKERS, Eindhoven (NL); Renatus De Zwart, Eindhoven (NL)

(21) Appl. No.: 15/127,740

(22) PCT Filed: Mar. 13, 2015
(86) PCT No.: PCT/EP2015/055313

§ 371 Date: Sep. 20, 2016

(30) Foreign Application Priority Data
Mar. 20, 2014 (EP) 14160805.9

(51) Int. Cl. F21V 23/06; F21K 9/272; F21S 8/04

(52) U.S. Cl. CPC F21V 23/06; F21Y 2115/10; F21S 8/043; F21K 9/272

(57) ABSTRACT

The present invention relates to an adaptor (1) for arrangement in a fluorescent lamp luminaire, comprising a connector member (10) shaped to fit into an electrical connector of a fluorescent lamp luminaire, wherein the connector member is electrically insulated, and an interface member (20) arranged to support a replacement light source to replace a fluorescent lamp in the luminaire. The invention further relates to a system comprising at least two such adaptors (1) and a bridge member (30) for supporting a replacement light source.

### FIELD OF THE INVENTION

The present invention relates to an adaptor for arrangement in a fluorescent lamp luminaire, and especially an adaptor for arrangement of a replacement light source in such luminaire.

### BACKGROUND OF THE INVENTION

Fluorescent tube luminaires have historically been widely used in many applications wherein a high luminous flux is desired. However, compared to other light sources such as Light Emitting Diode (LED) light sources, fluorescent lamps have a low efficiency and relatively high power consumption. It would therefore be desired to replace fluorescent tube luminaries with for instance LED luminaires to improve the efficiency and lower the energy costs for the luminaire. However, replacing all fluorescent lamp luminaires may be very costly.

The luminaire may be kept by only replacing the fluorescent lamp or tube. For instance, a fluorescent tube may be replaced by a TLED lamp that may use the electrical connections of the fluorescent tube luminaire. However, the TLED lamp has constraints regarding its mechanical shape and electrical connections to fit in the existing luminaire. Further, it is relatively expensive, which would make the replacement of the fluorescent lamps a still costly operation.

Consequently, there is a need for a cost-efficient solution for replacing low-efficient and high-power consuming fluorescent tubes in existing luminaires.

### SUMMARY OF THE INVENTION

It is an object of the present invention to overcome this problem, and to provide a simple solution for replacement of fluorescent tubes in existing luminaires.

According to a first aspect of the invention, this and other objects are achieved by an adaptor for arrangement in a fluorescent lamp luminaire, comprising a connector member shaped to fit into an electrical connector of a fluorescent lamp luminaire, wherein the connector member is electrically insulated, and an interface member arranged to support a replacement light source to replace a fluorescent lamp in the luminaire.

By providing an adaptor which may be arranged on the electrical connector of an existing luminaire, a replacement light source, such as a LED bar, may be arranged in the luminaire to replace the fluorescent tube. The shape and position of the electrical connector in a lamp foot in a fluorescent tube luminaire is well defined which provides a use of such adaptor in any fluorescent tube luminaire. The lamp foot houses a lamp socket, this lamp socket is the electrical fitting into which the fluorescent tube is inserted and subsequently powered by. The adaptor may be used for mechanically support a replacement light source. Since the adaptor is shaped for the defined shape of a fluorescent lamp luminaire, the replacement light source may have various designs and fit to be arranged on the adaptor. Since the connector member, adapted to be inserted in the electrical connector of the luminaire, is electrically insulated, the installation of a replacement light source with the adaptor may be a safe procedure for a user. In one embodiment, also the interface member or the entire adaptor is electrically insulated to further secure a safe situation for a user. The adaptor may be formed by a plastic material.

In one embodiment, the adaptor may further comprise a flat wall member, and the connector member may be formed as at least one protrusion from the flat wall member. The wall member may be connected to both the interface member and the connector member, to form a connection between those two members. The connector member may be formed as at least one protrusion, preferably one or two protrusions. The connector member may be formed as two protrusions as insulated pins shaped similar to connector pins on a fluorescent tube adapted to be arranged in the fluorescent lamp luminaire. Since the connector member is electrically insulated, it may as well be formed as one single protrusion, with a size similar to the connector pins on a fluorescent tube and the distance between such pins. The wall member may extend in a direction perpendicular to the extension of the interface member.

In one embodiment, the interface member may be provided with fastening means to lock a replacement light source thereto. Such fastening means may be screws, clips, a lock pin or the like. Depending on the shape of the replacement light source, the interface member may be provided with one or more fastening means to enable different attachment methods for the light source.

Further, the interface member may in one embodiment comprise an extending flat member that, when the adaptor is arranged in a horizontally arranged luminaire, may extend in a substantially horizontal plane, such that a replacement light source arranged thereto may abut an underside or an upper side of the extending flat member.

In one embodiment, the interface member may comprise an opening adapted to receive a replacement light source. The shape of the opening may be formed to suit a certain type replacement light source. The opening may in one example be a circular opening, or in another example a rectangular opening. The replacement light source may be a LED light source, for example a LED bar. A LED bar may be suitable when the fluorescent luminaire is a fluorescent tube luminaire and the lamp to be replaced is a fluorescent tube. The LED bar may then have an elongated shape to fit into the luminaire and be supported by one or more adaptors arranged in the lamp feet of the luminaire.

According to a second aspect of the invention, a fluorescent lamp replacement system is provided, comprising at least two adaptors as previously presented, and a bridge member adapted to be arranged to the interface members of the at least two adaptors and to support a replacement light source. A fluorescent lamp luminaire may be provided with two lamp feet for arranging two fluorescent tubes. One replacement light source may be arranged for replacing both such tubes. Two adaptors may thereby be arranged in the two lamp feet together with a bridge member. The replacement light source may thereby be arranged in the luminaire, supported by both adaptors.

According to a third aspect of the invention, a lighting device is provided, comprising at least one of the adaptors as previously presented, a fluorescent lamp luminaire and a replacement light source. In such a lighting device the conventional fluorescent tube light source is replaced by for instance two adaptors according to this invention and a light source connected to these adaptors.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a perspective view of an embodiment of the invention.

FIG. 2 shows a perspective view of a fluorescent lamp luminaire in which two adaptors according to an embodiment of the invention are arranged with a replacement light source.

FIGS. 3a-c shows top views of different embodiments of the invention.

FIGS. 4a-c shows perspective views of embodiments with different interface members.

FIG. 5 shows a side view of a replacement system according to an embodiment of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person. Like reference characters refer to like elements throughout.

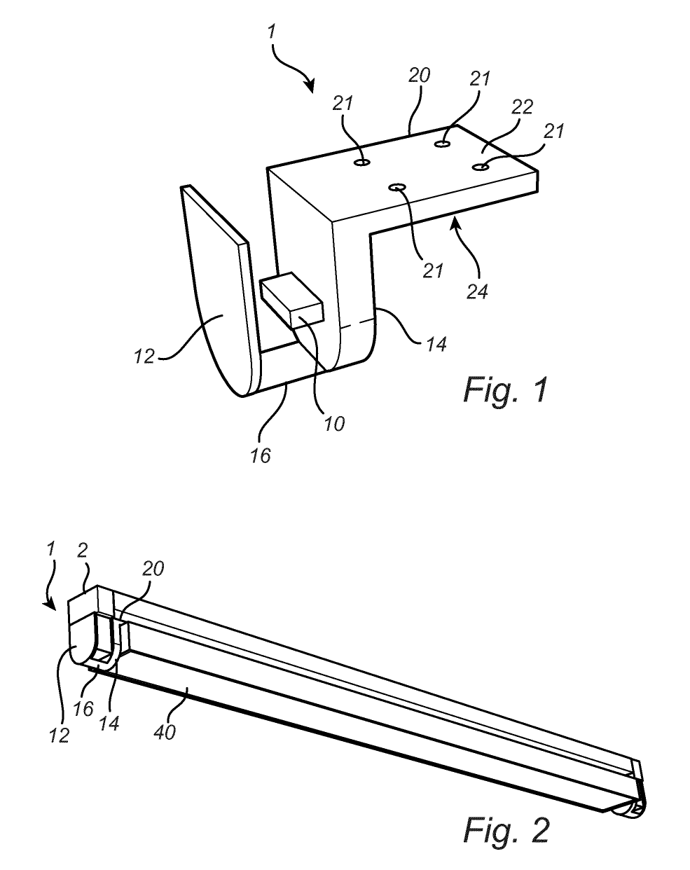

FIG. 1 illustrates an adaptor 1 according an embodiment of the invention. FIG. 2 further illustrates two such adaptors 1 arranged in a fluorescent lamp luminaire 2 with a replacement light source 40 in the form of a LED bar arranged between the two adaptors 1.

The adaptor 1 comprises a connector member 10. The connector member 10 is shaped to fit into an electrical connector of a fluorescent tube luminaire. The electrical connector of a fluorescent tube luminaire is arranged in a lamp foot and formed as a pin opening. A fluorescent tube is arranged in such electrical connector by being pushed into the pin opening and rotated 90° to be locked to the lamp foot. In the same way may the connector member 10 of the adaptor 1 be pushed into such pin opening and the adaptor may be rotated 90° to be locked in place. The connector member 10 is illustrated as a single protruding piece, but may as well be formed as two pin shaped pieces, arranged similar to connector pins on a fluorescent tube. The adaptor 1, or at least the connector member 10, is electrically insulated in order to eliminate a safety risk for a user arranging the adaptor 1 and any replacement light source 40 in the luminaire 2.

The connector member 10 is arranged in an enclosure comprising a first wall member 12, a second wall member 14 and an intermediate member 16 connecting the first wall member 12 to the second wall member 14. The connector member 10 protrudes from the second wall member 14. The enclosure is adapted to enclose the lamp foot of a luminaire in which the adaptor is arranged. The term enclose can mean fully or partially enclosed. That is to say the adaptor may completely enclose the lamp foot in order to prevent a user from touching the lamp foot or to provide mechanical stability to the adapter. The adapter may also only partially enclose the lamp foot, it may, for example only enclose the front and rear faces of the lamp foot or it may enclose the side faces of the lamp foot.

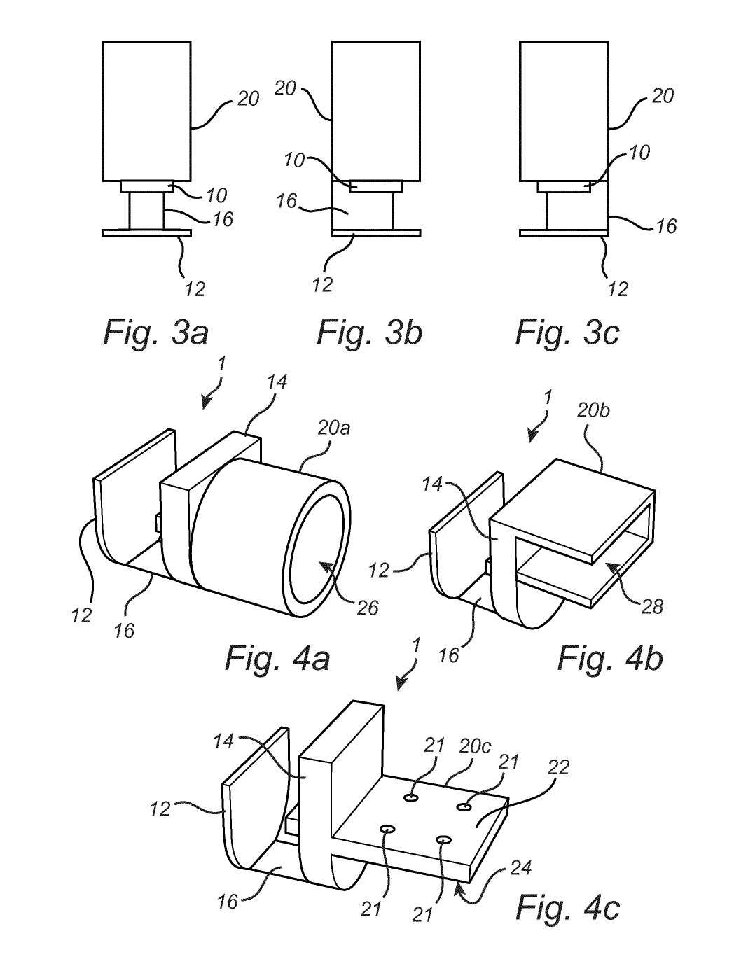

The adapter may also fully enclose a portion of the lamp foot, for example, the tip portion of the lamp foot down to the lamp socket or it may enclose the lamp foot all the way to the fixture base. As illustrated in FIGS. 3a-c, the intermediate member 16 may have different shapes in order to fit to different type of lamp feet in luminaires. The different top views of the adaptor 1 in FIGS. 3a-c illustrated intermediate members 16 arranged in the centre, to the left or to the right respectively.

On the second wall member 14 is an interface member 20 arranged. The interface member 20 has the purpose of supporting the replacement light source 40 to be arranged in the luminaire 2, such as a LED bar. The interface member 20 may have different shapes in order to be suitable for different types of light sources. FIG. 1 illustrates an interface member 20 shaped as an extending flat member. The extending flat member 20 extends perpendicular to the second wall member 14. Such orientation of the extending flat member 20 will provide that, when the adaptor 1 is arranged in a horizontally arranged luminaire 2, the extending flat member 20 extends in a horizontal direction, i.e. the replacement light source 40 will be horizontally arranged thereon. The extending flat member 20 has an upper side 22 and an underside 24. The replacement light source 40 may be attached to and abut the underside 24 of the extending flat member 20. In one embodiment, the extending flat member 20 comprises holes 21 which may be used for attaching the replacement light source 40 thereto, for instance by means of screws. The placement of the holes 21 may be selected to suit a specific type of light source. Other types of fastening means may be used for attaching the light source to the extending flat member 20.

FIG. 4a illustrates an embodiment wherein the interface member 20 is shaped as a hollow cylinder 20a. The cylinder 20a has an open interior 26 adapted to receive a replacement light source. Such embodiment may be used for light sources with a corresponding shape to fit into the interior 26 of the cylinder 20a. The cylinder 20a is attached to the second wall member 14 and extends perpendicular to a flat surface of the second wall member 14.

FIG. 4b illustrates an embodiment wherein the interface member 20 is shaped as an open hollow box 20b. The box 20b has an open interior 28 and an open side. The interior 28 is adapted to receive a replacement light source 40, such as a LED bar. The light source can be pushed into the box 20b through the open end to be fit into the interior 28. The box 20b may be provided with fastening means in order to lock the light source to the box 20b.

FIG. 4c illustrates an embodiment wherein the interface member 20 comprises an extending flat member 20c similar to the extending flat member in FIG. 1, but arranged at a lower portion of the second wall member 14. A light source 40 to be arranged to the extending flat member 20c is thereby to be supported on the upper side 22 of the extending flat member 20c. The light source 40 may rest thereon, and may in one embodiment be fastened to the flat member 20c. The extending flat member 20c may be provided with holes 21 which may be used for fastening the light source 40 thereto. Fastening means such as screws, lock pins, clips or the like may be used.

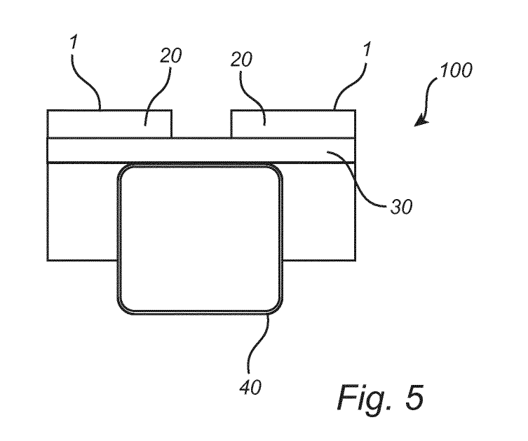

The adaptor 1 according to the invention may be used in fluorescent luminaires which is adapted for a double set of fluorescent tubes. In each end of the luminaire, two lamp feet are arranged. Such double tube arrangement may be replaced by a single LED bar 40. According to the invention and as illustrated in FIG. 5, a replacement system 100 comprises two adaptors 1 and a bridge member 30. The bridge member 30 is attached to the interface members 20 of the two adaptors 1. In the illustrated embodiment, the adaptors 1 comprises interface members in the shape of extending flat members 20 as illustrated in FIG. 1. The bridge member 30 may be attached to the extending flat members 20 in similar way as earlier described for attachment of a light source thereto.

On the bridge member 30, a light source 40, such as a LED bar, is arranged. The bridge member 30 may be provided with fastening means as earlier described for the interface members 20 in order to attach the light source 40 thereto.

The person skilled in the art realizes that the present invention by no means is limited to the preferred embodiments described above. On the contrary, many modifications and variations are possible within the scope of the appended claims. For example, the shape of the interface member may be varied to suit different types of light sources, and different fastening means may be provided on the adaptor to attach a light source to the adaptor.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage.

1. Adaptor for arrangement in a fluorescent lamp luminaire, comprising
a first wall member,
a second wall member,
an intermediate member,
a connector member shaped to fit into an electrical connector of a fluorescent lamp luminaire, and
an interface member arranged to support a replacement light source to replace a fluorescent lamp in the luminaire,
wherein the intermediate member connects the first wall member to the second wall member, the connector member is formed as at least one protrusion from the second wall member and is electrically insulated, and
wherein the adapter encloses the lamp foot of the fluorescent lamp luminaire.

2. The adaptor according to claim 1, wherein the interface member is provided with fastening means to lock a replacement light source thereto.

3. The adaptor according to claim 2, wherein the fastening means are screws, holes, clips, lock pin or the like.

4. The adaptor according to claim 1, wherein the interface member comprises an extending flat member that, when the adaptor is arranged in a horizontally arranged luminaire, extends in a substantially horizontal plane, such that a replacement light source arranged thereto would abut an underside or an upper side of the extending flat member.

5. The adaptor according to claim 1, wherein the interface member comprises an opening adapted to receive a replacement light source.

6. The adaptor according to claim 1, wherein the replacement light source is a LED light source.

7. The adaptor according to claim 1, wherein the fluorescent lamp luminaire is a fluorescent tube luminaire and the interface member is arranged to support a replacement light source to replace a fluorescent tube in the luminaire.

8. The adaptor according to claim 1, wherein the entire adaptor is electrically insulated.

9. The adaptor according to claim 1, wherein the adaptor is made of a plastics material.

10. A fluorescent lamp replacement system comprising at least two adaptors according to claim 1, and a bridge member adapted to be arranged to the at least two interface members and to support a replacement light source.

11. A lighting device comprising at least one adaptor according to claim 1, a fluorescent lamp luminaire and a replacement light source.
